(19) United States
(12) Patent Application Publication
(10) Pub. No.: US 2025/0106534 A1
(43) Pub. Date: Mar. 27, 2025

(54) LIGHT-RECEIVING ELEMENT AND ELECTRONIC APPARATUS

(71) Applicant: SONY SEMICONDUCTOR SOLUTIONS CORPORATION, KANAGAWA (JP)

(72) Inventor: YUTAKA INAOKA, KANAGAWA (JP)

(21) Appl. No.: 18/832,274

(22) PCT Filed: Dec. 23, 2022
(86) PCT No.: PCT/JP2022/047557

§ 371 Date: Jul. 23, 2024

(30) Foreign Application Priority Data
Jan. 31, 2022 (JP) 2022-013740

(51) Int. Cl. H04N 25/68; H04N 25/773

(52) U.S. Cl. CPC H04N 25/68; H04N 25/773

(57) ABSTRACT

Provided are a light-receiving element and an electronic apparatus capable of reducing the impact of a faulty counter circuit. The present disclosure provides a light-receiving element including a plurality of pixels and a control circuit, each of the pixels includes a sensing circuit capable of detecting incident photons and a counter circuit that counts pulses output from the sensing circuit or clock pulses output from the control circuit, and the counter circuit counts the clock pulses output from the control circuit in an inspection mode.

### TECHNICAL FIELD

The present disclosure relates to a light-receiving element and an electronic apparatus.

### BACKGROUND ART

There is known a light-receiving element provided, for each pixel, with a single-photon avalanche diode (SPAD) that detects the presence or absence of a photon and a counter circuit that counts the number of photons. There is, however, a possibility that one or some of the counter circuits may have poor characteristics.

### CITATION LIST

### Patent Document

Patent Document 1: Japanese Patent Application Laid-Open No. 2020-10093

### SUMMARY OF THE INVENTION

### Problems to be Solved by the Invention

Furthermore, it is required that a circuit that detects such a faulty counter circuit be downsized. Moreover, when power is supplied to a pixel in which a faulty counter circuit has been detected, the power consumption of the light-receiving element increases.

The present disclosure therefore provides a light-receiving element and an electronic apparatus capable of reducing the impact of a faulty counter circuit.

### Solutions to Problems

In order to solve the above-described problems, the present disclosure provides a light-receiving element including:
a plurality of pixels; and
a control circuit, in which
each of the pixels includes:
   a sensing circuit capable of detecting an incident photon; and
   a counter circuit that counts pulses output from the sensing circuit or clock pulses output from the control circuit, and
the counter circuit counts the clock pulses output from the control circuit in an inspection mode.

The counter circuit may count the pulses output from the sensing circuit in an imaging mode.

The control circuit may output a predetermined number of clock pulses in the inspection mode.

The counter circuit may be a multi-bit counter in which a high-level signal or a low-level signal is set for each bit on the basis of a number of pulses,
the control circuit may reset the counter circuit after outputting a first number of clock pulses, and output a second number of clock pulses different from the first number, and
the first number of clock pulses and the second number of clock pulses may be generated so as to make the high-level signal or the low-level signal of each bit set on the basis of count of the second number of clock pulses inverse to the high-level signal or the low-level signal of each bit set on the basis of count of the first number of clock pulses.

The counter circuit may be a multi-bit counter capable of initializing each bit with an initial value, and
the control circuit may set the initial value for each bit and output a predetermined number of clock pulses.

The counter circuit may be a multi-bit counter capable of initializing each bit with an initial value, and
the control circuit may set the initial value for each bit and output a clock pulse to a predetermined bit.

At least one of the plurality of photoelectric conversion elements may be configured as a pixel in which a light receiving unit is partially shielded from light by a light shielding member.

Each of the pixels may further include:
an avalanche photodiode;
a resistor connected in series to the avalanche photodiode between a power supply terminal and a ground terminal; and
a waveform shaping circuit that shapes an output signal of the avalanche photodiode into the pulses.

A memory that stores coordinates of an unusual pixel whose operation is unusual among the plurality of pixels may be further included.

Each of the pixels may further include a first switching element between the power supply terminal and the resistor, and
the first switching element corresponding to the coordinates of the unusual pixel may be disconnected.

Each of the pixels may further include a second switching element between the avalanche photodiode and a ground, and
the second switching element corresponding to the coordinates of the unusual pixel may be disconnected.

A correction circuit that generates an output value of the counter circuit corresponding to the coordinates of the unusual pixel on the basis of an output value of the counter circuit of a pixel adjacent to the unusual pixel may be further included.

A reading circuit that reads count from the counter circuit of each of the plurality of pixels in accordance with coordinates of the pixel may be further included.

In order to solve the above-described problems, the present disclosure provides an electronic apparatus including:
the light-receiving element; and
a determination circuit that sequentially compares the count read by the reading circuit from the counter circuit of each of the pixels with a predetermined number and determines whether or not the counter circuit of each of the pixels is faulty in the inspection mode.

The determination circuit may cause the memory to store coordinates of a pixel including the counter circuit determined to be faulty.

The determination circuit may be detachable.

An optical system that supplies imaging light to the light-receiving element may be further included.

### BRIEF DESCRIPTION OF DRAWINGS

FIG. 1 is a block diagram illustrating a configuration example of an imaging device.

FIG. 2 is a diagram illustrating an example of a multilayer structure of a light-receiving element.

FIG. 3 is a plan view illustrating a configuration example of a light-receiving chip.

FIG. 4 is a plan view illustrating a configuration example of a logic chip.

FIG. 5 is a block diagram schematically illustrating a circuit configuration example of an optical element.

FIG. 6 is a diagram illustrating an operation example of a multi-bit counter.

FIG. 7 is a diagram illustrating an operation example in a first inspection mode.

FIG. 8 is a diagram illustrating an example in which the multi-bit counter is, for example, a 12-bit counter.

FIG. 9 is a diagram illustrating an operation example in a second inspection mode.

FIG. 10 is a block diagram schematically illustrating a circuit configuration example of an optical element in a second embodiment.

FIG. 11 is a block diagram schematically illustrating a circuit configuration example of an optical element in a third embodiment.

FIG. 12 is a block diagram illustrating an example of a schematic configuration of a vehicle control system.

FIG. 13 is an explanatory diagram illustrating an example of installation positions of an outside-vehicle information detecting section and an imaging section.

### MODE FOR CARRYING OUT THE INVENTION

Hereinafter, preferred embodiments of the present disclosure will be described in detail with reference to the accompanying drawings. Note that, in the present specification and drawings, components having substantially the same functional configuration are denoted by the same reference numerals to avoid the description from being redundant.

### First Embodiment

### [Configuration Example of Imaging Device]

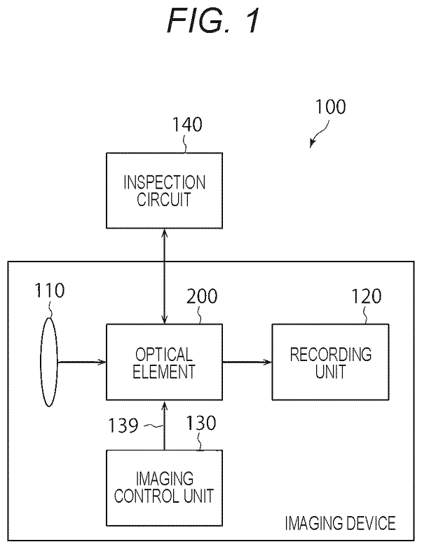

FIG. 1 is a block diagram illustrating a configuration example of an electronic apparatus 100 in a present embodiment. The electronic apparatus 100 is, for example, an apparatus capable of capturing image data. That is, the electronic apparatus 10 includes an imaging lens 110, a light-receiving element 200, a recording unit 120, an imaging control unit 130, and an inspection circuit 140. Possible examples of the electronic apparatus 100 include a smartphone, a digital camera, a personal computer, a vehicle-mounted camera, or an Internet of Things (IoT) camera.

The imaging lens 110 condenses incident light and guides the light to the light-receiving element 200. The light-receiving element 200 captures the image data under control of the imaging control unit 130. The light-receiving element 200 supplies the captured image data to the recording unit 120 via a signal line 209. The recording unit 120 records the image data.

The imaging control unit 130 controls the light-receiving element 200 to capture the image data. The imaging control unit 130 supplies, to the light-receiving element 200, for example, a synchronization signal such as a vertical synchronization signal via a signal line 139. Note that the electronic apparatus 100 may further include an interface and transmit the image data to outside via the interface, or may further include a display section and display the image data on the display section.

The inspection circuit 140 operates in conjunction with the light-receiving element 200 and the imaging control unit 130, for example. For example, the inspection circuit 140 is detachably attached to the electronic apparatus 100. The inspection circuit 140 is used for inspection at the time of manufacture of the electronic apparatus 100 and is used for detection of a faulty counter circuit, for example. Note that inspection circuit 140 may be provided in the imaging control unit 130.

### [Configuration Example of Light-Receiving Element]

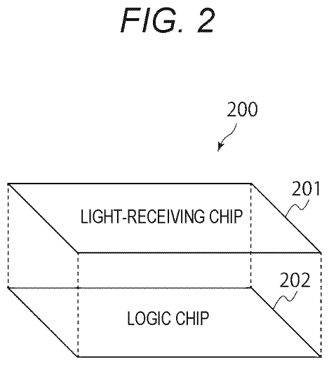

FIG. 2 is a diagram illustrating an example of a multilayer structure of the light-receiving element 200 in an embodiment of the present technology. This light-receiving element 200 includes a light-receiving chip 201 and a logic chip 202 stacked on the light-receiving chip 201. A signal line for transmitting a signal is provided between these chips. The light-receiving element 200 is a so-called photon-counting imaging element.

### [Configuration Example of Light-Receiving Chip]

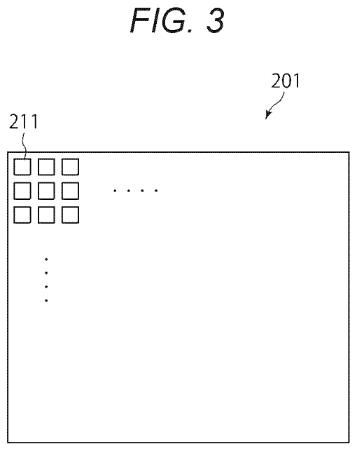

FIG. 3 is a plan view illustrating a configuration example of the light-receiving chip 201 in the embodiment of the present technology. The light-receiving chip 201 includes a plurality of sensing circuits 211 arranged in a two-dimensional lattice pattern. Furthermore, the sensing circuits 211 each include a single photon avalanche diode (SPAD). In the SPAD, avalanche amplification occurs when one photon enters a PN junction region of a high electric field in a state where a voltage larger than a breakdown voltage is applied. That is, in the light-receiving chip 201, a pixel array in which the sensing circuits 211 using the SPADs are arranged in a matrix is adopted. Hereinafter, an optical axis of incident light is defined as a Z-axis, and a predetermined axis perpendicular to the Z-axis is defined as an X-axis. Furthermore, an axis perpendicular to the X-axis and the Z-axis is defined as a Y-axis. The sensing circuits 211 are arranged along the X-axis direction and the Y-axis direction.

### [Configuration Example of Logic Chip]

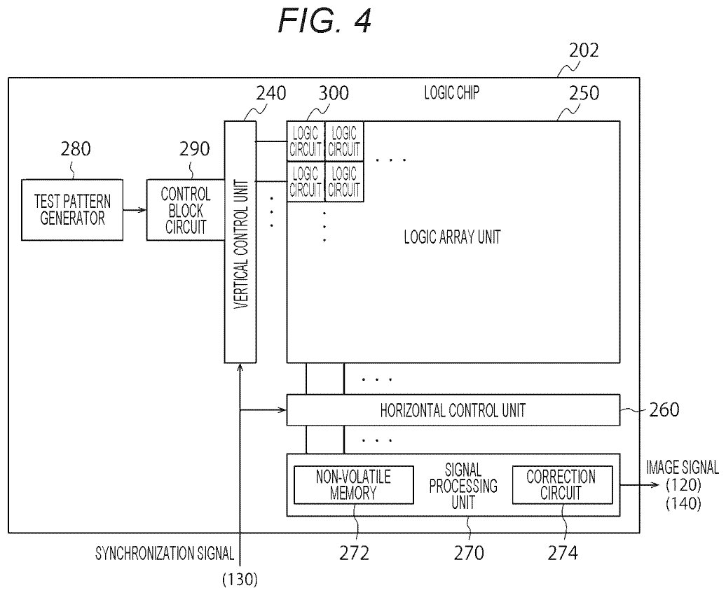

FIG. 4 is a plan view illustrating a configuration example of the logic chip 202 in the present embodiment. On the logic chip 202, a vertical control unit 240, a logic array unit 250, a horizontal control unit 260, and a signal processing unit 270 are arranged. Moreover, the signal processing unit 270 further includes a non-volatile memory 272 and a defect correction circuit 274. Note that the vertical control unit 240 and the horizontal control unit 260 according to the present embodiment correspond to a reading circuit.

Furthermore, in the logic array unit 250, a logic circuit 300 is arranged for each sensing circuit 211. Each of these logic circuits 300 is connected to the corresponding sensing circuit 211 via the signal line. A circuit including a sensing circuit 211 and a logic circuit 300 corresponding to the sensing circuit 211 functions as a pixel 110 that generates pixel data of one pixel in image data.

Then, a vertical synchronization signal is input to the vertical control unit 240, and a horizontal synchronization signal is input to the horizontal control unit 260. Hereinafter, a set of pixel circuits (sensing circuits 211 and logic circuits 300) arranged in a predetermined direction (such as a horizontal direction) is referred to as “row”, and a set of pixel circuits arranged in a direction perpendicular to the row is referred to as “column”.

The vertical control unit 240 sequentially selects the rows in synchronization with the vertical synchronization signal. The logic circuit 300 counts the number of photons incident during an exposure period, and outputs data indicating the counted value to the signal processing unit 270 as pixel data. The horizontal control unit 260 sequentially selects the columns in synchronization with the horizontal synchronization signal and outputs pixel data.

The signal processing unit 270 executes predetermined signal processing such as filter processing on the image data including an array of pieces of the pixel data. As described above, the signal processing unit 270 includes the non-volatile memory 272 and the correction circuit 274.

The non-volatile memory 272 stores coordinates of an unusual pixel including the faulty counter circuit detected by the inspection circuit 140. The correction circuit 274 generates an output value of the unusual pixel using output values of neighboring pixels. For example, an average of output values of eight neighboring pixels is used as the correction value.

### [Circuit Configuration Example in Optical Element 200]

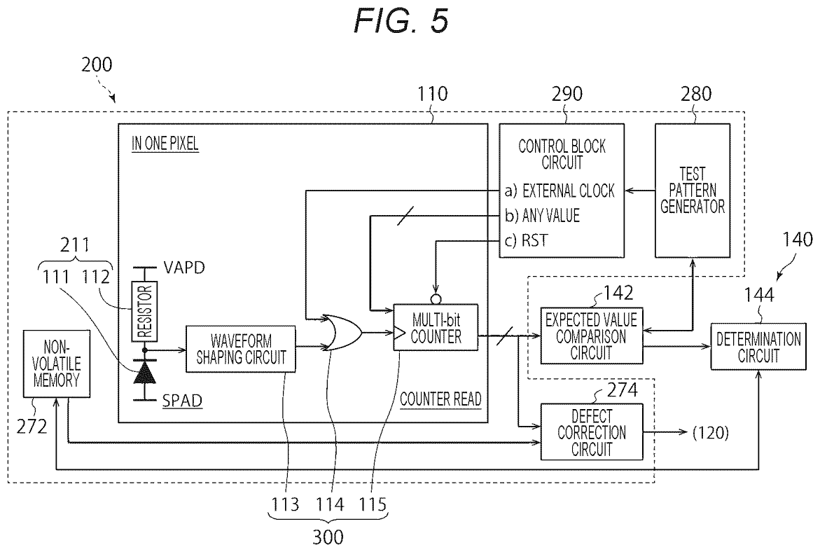

FIG. 5 is a block diagram schematically illustrating a circuit configuration example of an optical element 200 in the present embodiment. For simplicity of description, FIG. 5 shows only one pixel 110 and does not show the vertical control unit 270, the horizontal control unit 260, and the signal processing unit 270. The optical element 200 includes the plurality of pixels 110 as described above, the non-volatile memory 272 and the correction circuit 274 in the signal processing unit 270, a test pattern generator 280, and a control block circuit 290. Furthermore, the inspection circuit 140 (see FIG. 1) includes an expected value comparison circuit 142 and a determination circuit 144. Note that the control block circuit 290 according to the present embodiment corresponds to a control circuit.

The pixel 110 includes the sensing circuit 211 and the logic circuit 300 as described above. Furthermore, the sensing circuit 211 includes an avalanche photodiode (APD) 111 and a quench resistor 112. That is, the sensing circuit 211 acts as a SPAD. The logic circuit 300 includes a waveform shaping circuit 113, an OR circuit 114, and a multi-bit counter 115.

A bias voltage VAPD higher than or equal to the breakdown voltage is applied to the APD 111 via the quench resistor 112. When photons enter the APD 111 in this state, a large photocurrent flows due to avalanche multiplication, and a voltage drop occurs in the quench resistor 112. This causes a decrease in the bias voltage VAPD applied to the APD 111, and when the bias voltage VAPD decreases to the breakdown voltage, the avalanche multiplication stops. As a result, the photocurrent stops flowing, and a return to the state where the bias voltage VAPD is applied to the APD 101 is made. The quench resistor 112 is a resistive element for stopping the avalanche multiplication of the APD 111.

The waveform shaping circuit 113 amplifies a voltage at a connection point between the APD 111 and the quench resistor 112 and then performs edge detection to generate voltage pulses from voltage changes caused by incident photons. As describe above, the APD 111, the quench resistor 112, and the waveform shaping circuit 103 constitute the sensing circuit 211 capable of detecting a single incident photon.

The voltage pulses are supplied from the waveform shaping circuit 113 to the OR circuit 114 during normal imaging. The multi-bit counter 115 counts the number of pulses supplied from the OR circuit 114 during normal imaging. On the other hand, during inspection, clock pulses for testing are input from the control block circuit 290. This allows the multi-bit counter 115 to count the clock pulses for testing during inspection. Note that the multi-bit counter 115 according to the present embodiment corresponds to a counter circuit.

The multi-bit counter 115 includes flip-flop (FF) circuits based on the bit depth, for example. During normal imaging, the multi-bit counter 115 is reset by a reset signal at the end of imaging. On the other hand, the multi-bit counter 115 can set an initial value based on a test pattern and count the clock pulses during testing. Moreover, the multi-bit counter 115 is capable of supplying clock pulses to each flip-flop (FF) circuit associated with the corresponding bit, for example. The multi-bit counter 115 can therefore increase a counter value for each bit relative to the set initial value.

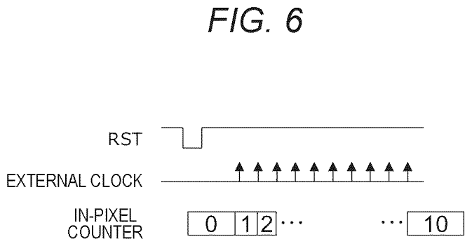

FIG. 6 is a diagram illustrating an operation example of the multi-bit counter 115. Time-series changes of the reset signal, the external clock, and the in-pixel counter are illustrated in this order from the upper side. The horizontal axis represents time. The vertical axis of the reset (RST) signal represents a signal level, and the multi-bit counter 115 is reset when the signal level is low. Arrows of the external clock each indicate a test clock pulse supplied from the control block circuit 290. In FIG. 6, each bit is set to 0 as the initial value. Furthermore, clock pulses are supplied in time series. The in-pixel counter increases a count value from the initial value 0 in response to the supplied clock pulses. As described above, the multi-bit counter 115 is a counter that can be reset in accordance with the reset signal and initialize each bit with the initial value.

The test pattern generator 280 generates, as the test pattern, the initial value for each bit of the multi-bit counter 115 at the time of inspecting the multi-bit counter 115. Any desired value can be set as the initial value and is supplied to the multi-bit counter 115 during inspection. The test pattern generator 280 and the control block 290 control the multi-bit counter 115 in conjunction with the expected value comparison circuit 142 and the determination circuit 144 during inspection.

The control block 290 is a circuit that controls the multi-bit counter 115. The control block 290 can generate a clock signal and supply the clock signal to the OR circuit 114 during inspection. At this time, the control block 290 can supply the clock signal for each bit of the multi-bit counter 115 to increase the counter value.

Furthermore, the control block 290 sets, to the multi-bit counter 115, the test pattern supplied from the test pattern generator 280. Moreover, the control block 290 generates the reset signal and supplies the reset signal to the multi-bit counter 115.

The test pattern generator 280 and the control block 290 have a plurality of inspection modes. A first inspection mode is a mode in which the control block 290 supplies, to the OR circuit 114, the number of clock pulses based on the number supplied from the test pattern generator 280. A second inspection mode is a mode in which the control block 290 initializes the multi-bit counter 115 with bit data corresponding to the initial value supplied from the test pattern generator 280, and thereafter supplies, to each bit, clock pulses based on the position of the bit and the number of times supplied from the test pattern generator 280.

The expected value comparison circuit 142 compares a numerical value supplied from the test pattern generator 280 with a numerical value supplied from the multi-bit counter 115. The determination circuit 144 determines whether or not the multi-bit counter 115 is faulty on the basis of on a comparison result from the expected value comparison circuit 142. When determining that the multi-bit counter 115 is faulty, the determination circuit 144 stores the coordinates of the pixel 110 including the faulty multi-bit counter 115 in the non-volatile memory 272.

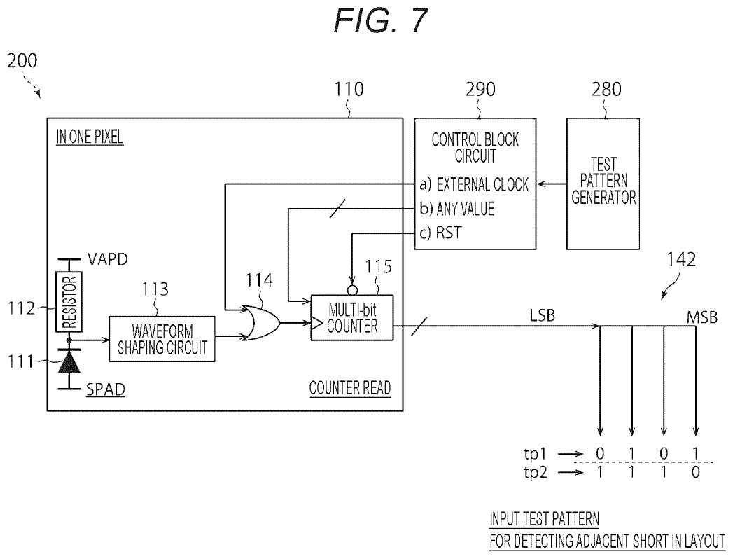

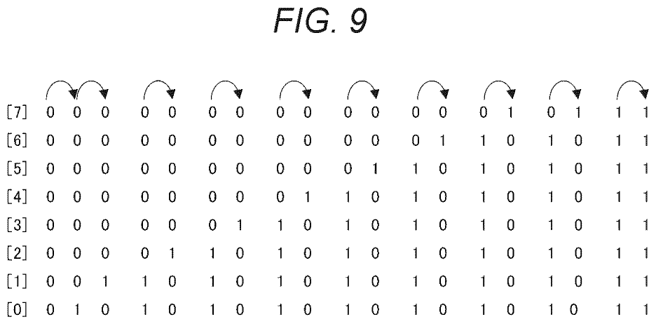

Here, an operation example in each inspection mode will be described with reference to FIGS. 7 and 9 together with FIG. 4. FIG. 7 is a diagram illustrating an operation example in the first inspection mode. Here, a case where tp1 (test pattern 1) and tp2 (test pattern 2) are supplied will be described. tp1 (test pattern 1) is, for example, 9 that is 0101 in bit representation, and tp2 (test pattern 2) is, for example, 5 that is 1010 in bit representation (in the drawing, 1110 due to a malfunction). In the first inspection mode, numerical values that make each bit value of tp1 (test pattern 1) and the corresponding bit value of tp2 (test pattern 2) different from each other are set. Therefore, for example, even in a case where a certain bit of the multi-bit counter 115 is faulty to always output 1 or 0, it is possible to make a determination by inverting the bit. For example, in FIG. 7, the second bit is erroneously determined to hold 1, and it is difficult to make a determination only with tp1 (test pattern 1), but it is possible to make a determination with both tp1 and tp2 (test pattern 2).

More specifically, the test pattern generator 280 first supplies, for example, 9 to the control block 290 and the expected value comparison circuit 142. After resetting each bit of each pixel 110 to 0, the control block 290 supplies nine clock pulses to the multi-bit counter 115 of each pixel 110 as tp1 (test pattern 1).

In this case, for example, in a case of 4-bit length, the multi-bit counter 115 of each pixel 110 is set to 0101. The vertical control unit 240 and the horizontal control unit 260 sequentially select columns in synchronization with the vertical synchronization signal and the horizontal synchronization signal to sequentially output the values of the multi-bit counters 115 as pixel data.

Next, upon receipt of a signal indicating the end of the clock pulses from the control block 290, the expected value comparison circuit 142 sequentially compares the output value of the multi-bit counter 115 of each pixel 110 with the value, for example, 9 supplied from the test pattern generator 280.

The expected value comparison circuit 142 sequentially outputs a high-level signal (1) in a case where the numerical values are the same, and outputs a low-level signal (0) in a case where the numerical values are different. Since the values are the same for one pixel 110 in FIG. 7, the expected value comparison circuit 142 outputs the high-level signal (1) to the determination circuit 144. When receiving the high-level signal (1), the determination circuit 144 does not register the coordinates.

Next, after resetting each bit of each pixel 110 to 0, the control block 290 supplies two clock pulses to the multi-bit counter 115 of each pixel 110 as tp2 (test pattern 2).

In this case, for example, in a case of 4-bit length, the multi-bit counter 115 of each pixel 110 is set to 1010.

The vertical control unit 240 and the horizontal control unit 260 sequentially select rows and columns in synchronization with the vertical synchronization signal and the horizontal synchronization signal to sequentially output the values of the multi-bit counters 115 as pixel data.

Next, upon receipt of a signal indicating the end of the clock pulses from the control block 290, the expected value comparison circuit 142 sequentially compares the output value of the multi-bit counter 115 of each pixel 110 with the value, for example, 5, supplied from the test pattern generator 280.

The expected value comparison circuit 142 sequentially outputs a high-level signal (1) in a case where the numerical values are the same, and outputs a low-level signal (0) in a case where the numerical values are different. In this case, for example, the multi-bit counter 115 of the pixel 110 illustrated in the drawing should be set to 1010 in a case of 4-bit length but set to 1110 due to a malfunction. Therefore, since the values are different for one pixel 110 in FIG. 7, the expected value comparison circuit 142 outputs the low-level signal (0) to the determination circuit 144. When receiving the low-level signal (0), the determination circuit 144 registers the unusual pixel on the basis of coordinates read by the vertical control unit 240 and the horizontal control unit 260. As described above, it is possible to determine whether or not the multi-bit counter 115 of each pixel 110 is faulty, in a manner similar to normal image data reading, through the reading by the vertical control unit 240 and the horizontal control unit 260. It is therefore possible to determine whether or not the multi-bit counter 115 of each pixel 110 is faulty only by adding the test pattern generator 280 and the control block 290, and it is thus possible to suppress an increase in the circuit scale of the optical element 200.

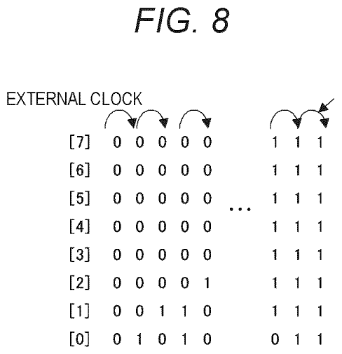

FIG. 8 is a diagram illustrating an example in which the multi-bit counter 115 is a 12-bit counter, for example. [0] to [7] each represent a bit string of the multi-bit counter 115 at a certain timing. As illustrated in FIG. 8, in a case where the bit depth of the multi-bit counter 115 is large, it takes time to supply clocks in the inspection mode 1. Therefore, as illustrated in FIG. 9, in a case where the bit depth of the multi-bit counter 115 is large, it is possible to perform the inspection in the second inspection mode.

FIG. 9 is a diagram illustrating an operation example in the second inspection mode. [0] to [7] each represent a bit string of the multi-bit counter 115 at a certain timing. At timing [0], each bit is initially set to [01010101010101011].

First, for the lower 3 bits, the test pattern generator 280 supplies, for example, 5 to the expected value comparison circuit 142. After setting each bit of the multi-bit counter 115 to [01010101010101011], the control block 290 supplies five clock pulses from the least significant bit. Also in the second inspection mode, each time inspection occurs, the vertical control unit 240 and the horizontal control unit 260 sequentially output the values of the multi-bit counters 115 as pixel data in synchronization with the vertical synchronization signal and the horizontal synchronization signal.

The expected value comparison circuit 142 sequentially compares the first to sixth values that should be output from the multi-bit counters 115 with five correct values supplied by the test pattern generator 280 for each clock pulse and for each pixel 110. The timing [1] indicates a state where two clock pulses have been supplied and the result is correct, so that the expected value comparison circuit 142 supplies the high-level signal (1) to the determination circuit 144 for each clock pulse. The timing [2] indicates a case where four clock pulses have been further supplied and the result is correct, so that the expected value comparison circuit 142 supplies the high-level signal (1) to the determination circuit 144 for each clock pulse. Through such processing, the operation check for the lower-order bits is complete. As described above, since the lower-order bits are immediately counted up, the test pattern generator 280 continuously inputs clocks to cause the expected value comparison circuit 142 and the determination circuit 144 to perform the determination processing.

Next, at timing [3], the clock pulse is supplied to set the fifth bit to 1. Then, the vertical control unit 240 and the horizontal control unit 260 sequentially makes a selection in synchronization with the vertical synchronization signal and the horizontal synchronization signal and sequentially output the values of the multi-bit counters 115 as pixel data. Since the result is correct for the pixel 110 illustrated in FIG. 9, the expected value comparison circuit 142 supplies the high-level signal (1) to the determination circuit 144.

Next, at timing [4], the clock pulse is supplied to set the sixth bit to 1. Then, the vertical control unit 240 and the horizontal control unit 260 sequentially makes a selection in synchronization with the vertical synchronization signal and the horizontal synchronization signal and sequentially output the values of the multi-bit counters 115 as pixel data. Since the result is correct for the pixel 110 illustrated in FIG. 9, the high-level signal (1) is supplied to the determination circuit 144.

Next, at timing [5], the clock pulse is supplied to set the seventh bit to 1. Then, the vertical control unit 240 and the horizontal control unit 260 sequentially makes a selection in synchronization with the vertical synchronization signal and the horizontal synchronization signal and sequentially output the values of the multi-bit counters 115 as pixel data. Since the result is correct for the pixel 110 illustrated in FIG. 9, the expected value comparison circuit 142 supplies the high-level signal (1) to the determination circuit 144.

Next, at timing [6], the clock pulse is supplied to set the eighth bit to 1. Then, the vertical control unit 240 and the horizontal control unit 260 sequentially makes a selection in synchronization with the vertical synchronization signal and the horizontal synchronization signal and sequentially output the values of the multi-bit counters 115 as pixel data. Since the result is correct for the pixel 110 illustrated in FIG. 9, the expected value comparison circuit 142 supplies the high-level signal (1) to the determination circuit 144.

Next, at timing [7], the clock pulse is supplied to set the ninth bit to 1. Then, the vertical control unit 240 and the horizontal control unit 260 sequentially makes a selection in synchronization with the vertical synchronization signal and the horizontal synchronization signal and sequentially output the values of the multi-bit counters 115 as pixel data. Since the result is correct for the pixel 110 illustrated in FIG. 9, the expected value comparison circuit 142 supplies the high-level signal (1) to the determination circuit 144. As described above, after the end of the operation check for the lower-order bits, the operation check for each bit is sequentially performed. As for the higher-order bits, a combination with writing of any desired value makes it possible to determine a bit position for writing of any desired value (bit carry) so as to minimize the testing time.

As described above, according to the present embodiment, the light-receiving element 200 includes the plurality of pixels 110 and the control block circuit 290, each of the pixels 110 includes the sensing circuit 211 capable of detecting a single incident photon and the multi-bit counter 115 that counts the pulses output from the sensing circuit 211 or the clock pulses output from the control block circuit 290, and the multi-bit counter 115 counts the clock pulses output from the control block circuit 290 in the inspection mode. It is therefore possible to determine, by comparing the number of clock pulses output from the control block circuit 290 with the number counted by the multi-bit counter 115, whether or not the multi-bit counter 115 is faulty.

### Second Embodiment

An electronic apparatus 100 according to a second embodiment is different from the electronic apparatus 100 according to the first embodiment in that driving the APD 111 of the pixel 110 registered as an unusual pixel is stopped. Hereinafter, a difference from the electronic apparatus 100 according to the first embodiment will be described.

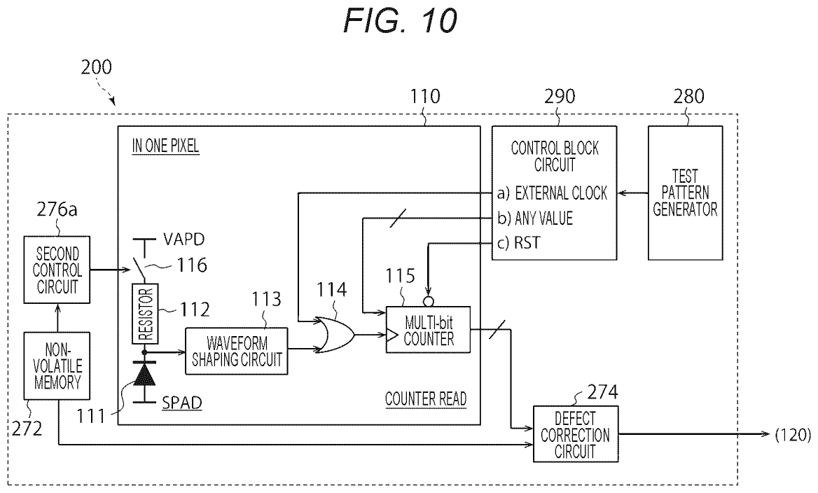

FIG. 10 is a block diagram schematically illustrating a circuit configuration example of an optical element 200 in the second embodiment. For simplicity of description, FIG. 10 shows only one pixel 110 and does not show the vertical control unit 270, the horizontal control unit 260, and the signal processing unit 270. As illustrated in FIG. 10, the pixel 110 includes a switching element 116 between the quench resistor 112 and the bias voltage VAPD. The optical element 200 further includes a control circuit 276a. For example, the second control circuit 276a is provided in the signal processing unit 270 (see FIG. 4).

The second control circuit 276a disconnects the switching element 116 corresponding to the coordinates of the unusual pixel recorded in the non-volatile memory 272. It is therefore possible to stop driving the avalanche photodiode (APD) 111 of the faulty pixel 110 of the multi-bit counter 115. This reduces power consumption in the avalanche photodiode (APD) 111.

### Third Embodiment

An electronic apparatus 100 according to a third embodiment is different from the electronic apparatus 100 according to the second embodiment in that a switching element 118 is provided between the avalanche photodiode (APD) 111 and the ground. Hereinafter, a difference from the electronic apparatus 100 according to the second embodiment will be described.

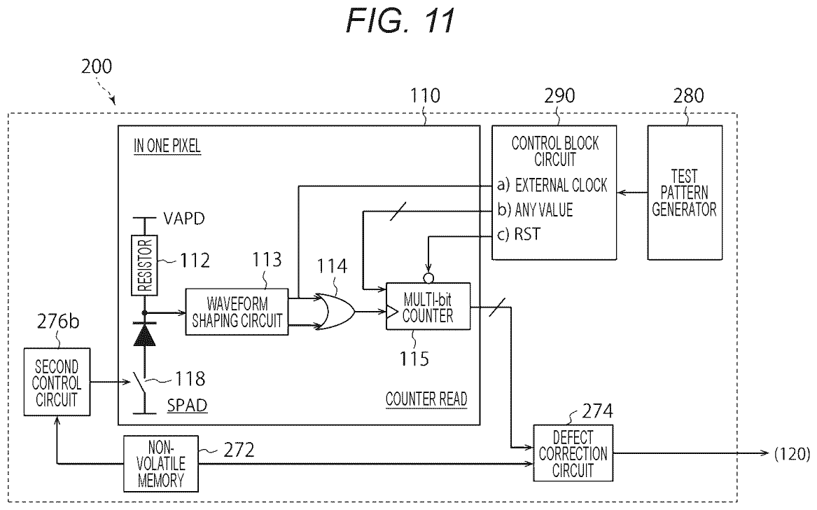

FIG. 11 is a block diagram schematically illustrating a circuit configuration example of an optical element 200 in the third embodiment. For simplicity of description, FIG. 11 shows only one pixel 110 and does not show the vertical control unit 270, the horizontal control unit 260, and the signal processing unit 270. As illustrated in FIG. 11, the pixel 110 includes the switching element 118 between the avalanche photodiode (APD) 111 and the ground. The optical element 200 further includes a control circuit 276b. For example, the second control circuit 276b is provided in the signal processing unit 270 (see FIG. 4).

The second control circuit 276b disconnects the switching element 118 corresponding to the coordinates of the unusual pixel recorded in the non-volatile memory 272. It is therefore possible to stop driving the avalanche photodiode (APD) 111 of the faulty pixel 110 of the multi-bit counter 115. This reduces power consumption in the avalanche photodiode (APD) 111.

### <<1. Application Example>>

The technology according to the present disclosure can be applied to various products. For example, the technology according to the present disclosure may also be implemented as a device mounted on any kind of mobile body such as an automobile, an electric automobile, a hybrid electric automobile, a motorcycle, a bicycle, a personal mobility, an airplane, a drone, a ship, a robot, a construction machine, an agricultural machine (tractor), or the like.

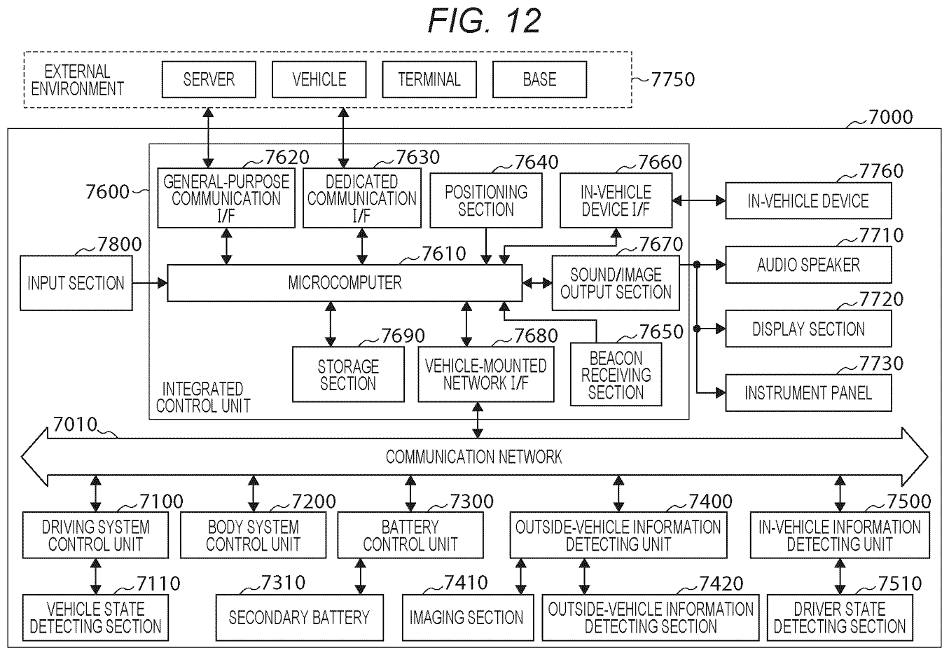

FIG. 12 is a block diagram illustrating a schematic configuration example of a vehicle control system 7000 as an example of a mobile body control system to which the technology of the present disclosure is applied. The vehicle control system 7000 includes a plurality of electronic control units connected to each other via a communication network 7010. In the example illustrated in FIG. 12, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. A functional configuration of the integrated control unit 7600 illustrated in FIG. 12 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

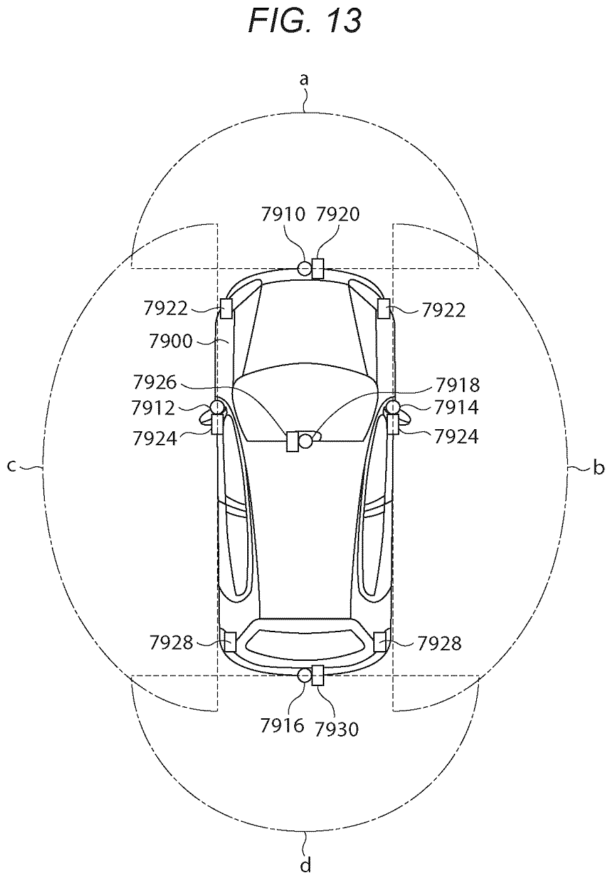

Here, FIG. 13 illustrates an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Note that FIG. 13 illustrates an example of the imaging range of each of the imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Referring back to FIG. 12, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 that are present in the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automated driving, which makes the vehicle to travel automatedly without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example in FIG. 12, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Note that, in the example illustrated in FIG. 12, at least two control units connected to each other via the communication network 7010 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

Note that a computer program for implementing each function of the electronic apparatus 100 according to the present embodiment described with reference to FIG. 1 can be implemented in any of the control units or the like. Furthermore, a computer-readable recording medium in which such a computer program is stored can be provided. The recording medium is, for example, a magnetic disk, an optical disc, a magneto-optical disk, a flash memory, or the like. Furthermore, the computer program described above may be distributed via, for example, a network without using a recording medium.

In the vehicle control system 7000 described above, the electronic apparatus 100 according to the present embodiment described with reference to FIG. 1 can be applied to the imaging section 7410 of the application example illustrated in FIG. 12.

Furthermore, at least some of the components of the electronic apparatus 100 described with reference to FIG. 1 may be implemented in a module (e.g., an integrated circuit module constituted by one die) for the integrated control unit 7600 illustrated in FIG. 12. Alternatively, the electronic apparatus 100 described with reference to FIG. 1 may be implemented by a plurality of control units of the vehicle control system 7000 illustrated in FIG. 12.

Note that the present technology may have the following configurations.

(1)

A light-receiving element including:
a plurality of pixels; and
a control circuit, in which
each of the pixels includes:
   a sensing circuit capable of detecting an incident photon; and
   a counter circuit that counts pulses output from the sensing circuit or clock pulses output from the control circuit, and
the counter circuit counts the clock pulses output from the control circuit in an inspection mode.
   (2)

The light-receiving element according to (1), in which
the counter circuit counts the pulses output from the sensing circuit in an imaging mode.
   (3)

The light-receiving element according to (1), in which
the control circuit outputs a predetermined number of clock pulses in the inspection mode.
   (4)

The light-receiving element according to (1), in which
the counter circuit is a multi-bit counter in which a high-level signal or a low-level signal is set for each bit on the basis of a number of pulses,
the control circuit resets the counter circuit after outputting a first number of clock pulses, and outputs a second number of clock pulses different from the first number, and
the first number of clock pulses and the second number of clock pulses are generated so as to make the high-level signal or the low-level signal of each bit set on the basis of count of the second number of clock pulses inverse to the high-level signal or the low-level signal of each bit set on the basis of count of the first number of clock pulses.
   (5)

The light-receiving element according to (1), in which
the counter circuit is a multi-bit counter capable of initializing each bit with an initial value, and
the control circuit sets the initial value for each bit and outputs a predetermined number of clock pulses.
   (6)

The light-receiving element according to (1), in which
the counter circuit is a multi-bit counter capable of initializing each bit with an initial value, and
the control circuit sets the initial value for each bit and outputs a clock pulse to a predetermined bit.
   (7)

The light-receiving element according to (1), in which
each of the pixels further includes:
   an avalanche photodiode;
   a resistor connected in series to the avalanche photodiode between a power supply terminal and a ground terminal; and
   a waveform shaping circuit that shapes an output signal of the avalanche photodiode into the pulses.
      (8)

The light-receiving element according to (7), further including a memory that stores coordinates of an unusual pixel whose operation is unusual among the plurality of pixels.

(9)

The light-receiving element according to (8), in which
each of the pixels further includes a first switching element between the power supply terminal and the resistor, and
the first switching element corresponding to the coordinates of the unusual pixel is disconnected.
   (10)

The light-receiving element according to (8), in which
each of the pixels further includes a second switching element between the avalanche photodiode and a ground, and
the second switching element corresponding to the coordinates of the unusual pixel is disconnected.
   (11)

The light-receiving element according to (8), further including a correction circuit that generates an output value of the counter circuit corresponding to the coordinates of the unusual pixel on the basis of an output value of the counter circuit of a pixel adjacent to the unusual pixel.

(12)

The light-receiving element according to (8), further including a reading circuit that reads count from the counter circuit of each of the plurality of pixels in accordance with coordinates of the pixel.

(13)

An electronic apparatus including:
the light-receiving element according to (12); and
a determination circuit that sequentially compares the count read by the reading circuit from the counter circuit of each of the pixels with a predetermined number and determines whether or not the counter circuit of each of the pixels is faulty in the inspection mode.
   (14)

The electronic apparatus according to (13), in which
the determination circuit causes the memory to store coordinates of a pixel including the counter circuit determined to be faulty.
   (15)

The electronic apparatus according to (14), in which
the determination circuit is detachable.
   (16)

The electronic apparatus according to (14), further including an optical system that supplies imaging light to the light-receiving element.

Aspects of the present disclosure are not limited to the above-described individual embodiments, but include various modifications that can be conceived by those skilled in the art, and the effects of the present disclosure are not limited to the above-described contents. That is, various additions, modifications, and partial deletions are possible without departing from the conceptual idea and spirit of the present disclosure derived from the matters defined in the claims and equivalents thereof.

### REFERENCE SIGNS LIST

100 Electronic apparatus
110 Optical system
111 Avalanche photodiode
112 Quench resistor 112
113 Waveform shaping circuit
115 Multi-bit counter
116 Switching element
118 Switching element
200 Optical element
211 Sensing circuit
240 Vertical control unit
260 Horizontal control unit
274 Defect correction circuit (correction circuit)
290 Control block circuit

1. A light-receiving element comprising:
a plurality of pixels; and
a control circuit, wherein
each of the pixels includes:
a sensing circuit capable of detecting an incident photon; and
a counter circuit that counts pulses output from the sensing circuit or clock pulses output from the control circuit, and
the counter circuit counts the clock pulses output from the control circuit in an inspection mode.

2. The light-receiving element according to claim 1, wherein
the counter circuit counts the pulses output from the sensing circuit in an imaging mode.

3. The light-receiving element according to claim 1, wherein
the control circuit outputs a predetermined number of clock pulses in the inspection mode.

4. The light-receiving element according to claim 1, wherein
the counter circuit is a multi-bit counter in which a high-level signal or a low-level signal is set for each bit on a basis of a number of pulses,
the control circuit resets the counter circuit after outputting a first number of clock pulses, and outputs a second number of clock pulses different from the first number, and
the first number of clock pulses and the second number of clock pulses are generated so as to make the high-level signal or the low-level signal of each bit set on a basis of count of the second number of clock pulses inverse to the high-level signal or the low-level signal of each bit set on a basis of count of the first number of clock pulses.

5. The light-receiving element according to claim 1, wherein
the counter circuit is a multi-bit counter capable of initializing each bit with an initial value, and
the control circuit sets the initial value for each bit and outputs a predetermined number of clock pulses.

6. The light-receiving element according to claim 1, wherein
the counter circuit is a multi-bit counter capable of initializing each bit with an initial value, and
the control circuit sets the initial value for each bit and outputs a clock pulse to a predetermined bit.

7. The light-receiving element according to claim 1, wherein
each of the pixels further includes:
an avalanche photodiode;
a resistor connected in series to the avalanche photodiode between a power supply terminal and a ground terminal; and
a waveform shaping circuit that shapes an output signal of the avalanche photodiode into the pulses.

8. The light-receiving element according to claim 7, further comprising a memory that stores coordinates of an unusual pixel whose operation is unusual among the plurality of pixels.

9. The light-receiving element according to claim 8, wherein
each of the pixels further includes a first switching element between the power supply terminal and the resistor, and
the first switching element corresponding to the coordinates of the unusual pixel is disconnected.

10. The light-receiving element according to claim 8, wherein
each of the pixels further includes a second switching element between the avalanche photodiode and a ground, and
the second switching element corresponding to the coordinates of the unusual pixel is disconnected.

11. The light-receiving element according to claim 8, further comprising a correction circuit that generates an output value of the counter circuit corresponding to the coordinates of the unusual pixel on a basis of an output value of the counter circuit of a pixel adjacent to the unusual pixel.

12. The light-receiving element according to claim 8, further comprising a reading circuit that reads count from the counter circuit of each of the plurality of pixels in accordance with coordinates of the pixel.

13. An electronic apparatus comprising:
the light-receiving element according to claim 12; and
a determination circuit that sequentially compares the count read by the reading circuit from the counter circuit of each of the pixels with a predetermined number and determines whether or not the counter circuit of each of the pixels is faulty in the inspection mode.

14. The electronic apparatus according to claim 13, wherein
the determination circuit causes the memory to store coordinates of a pixel including the counter circuit determined to be faulty.

15. The electronic apparatus according to claim 14, wherein
the determination circuit is detachable.

16. The electronic apparatus according to claim 14, further comprising an optical system that supplies imaging light to the light-receiving element.
